(19) United States
(12) Patent Application Publication
(10) Pub. No.: US 2026/0274754 A1
(43) Pub. Date: Sep. 17, 2026

(54) PROCESS FOR VATERITE PRODUCTION VIA THE CARBONATION OF LIME, AND HYDRATED LIME AND ALKALINE CA-CONTAINING PRECURSORS

(71) Applicant: The Regents of the University of California, Oakland, CA (US)

(72) Inventors: Gaurav Sant, Los Angeles, CA (US); Dante Simonetti, Los Angeles, CA (US); Jenny Arabit, Los Angeles, CA (US); Thomas Traynor, Los Angeles, CA (US); Dale Prentice, Los Angeles, CA (US); Fabian Rosner, Los Angeles, CA (US)

(21) Appl. No.: 19/480,248

(22) PCT Filed: May 13, 2024
(86) PCT No.: PCT/US2024/029062

§ 371 Date: Oct. 30, 2025

Related U.S. Application Data
(60) Provisional application No. 63/465,658, filed on May 11, 2023.

(51) Int. Cl. C04B 35/515; B01J 8/08; C01F 11/18; C04B 35/626

(52) U.S. Cl. CPC C04B 35/515; B01J 8/085; C01F 11/183; C04B 35/62655; C04B 35/62675; C01P 2002/72; C01P 2002/82

(57) ABSTRACT

The present invention provides tri-phasic methods of preparing a vaterite composition from a calcium source, such as calcium hydroxide, and carbon dioxide. The methods advantageously produce a calcium carbonate with high conversion and selectivity for the vaterite polymorph. The present invention further provides vaterite compositions and systems for producing vaterite.

### CROSS REFERENCE TO RELATED APPLICATIONS

This application claims the benefit of priority to U.S. Provisional Patent Application No. 63/465,658, filed May 11, 2023, the contents of which are herein incorporated by reference in their entirety.

### BACKGROUND

Cement production accounts for roughly 7% of the global CO₂ emissions with an estimated carbon intensity of about 0.78-0.89 tCO₂/t cement produced in the United States in 2019.1 The international energy agency (IEA) estimates an annual 3% reduction in cement production and demand until 2030 would be needed to achieve the “Net Zero scenario by 2050”0.2 This is in great contradiction with the upward historical trend of cement production, which predicts an annual 1.8% increase for 2015-2020.^{2,3} To proactively reduce the CO₂ emissions from cement production, alternative cementitious materials are needed to replace the CO₂ intensive material.

A calcium carbonate polymorph, vaterite, is a viable cement replacement option. Recent studies indicate that the polymorphic transformation of metastable vaterite to aragonite and/or calcite induces cementitious properties that are comparable to that of an Ordinary Portland Cement (OPC) formulation.⁴⁻⁶ The strength gain was attributed to the porous “honeycombed” microstructure produced by the intertwining needle-shaped aragonite when the precursor spherical vaterite particles dissolve. Other studies have also shown that the cementitious property of the vaterite to calcite transition may be a promising consolidating agent for preserving historical buildings.^{7,8} Beyond construction materials, vaterite has also been proposed as a material of interest for various biomedical and wastewater treatment applications.^{9,10} However, the thermodynamic instability of vaterite (as shown in Table 1) often renders it as a transitionary phase (i.e., on account of its rapid transformation into calcite or aragonite) causing technical challenges to produce at industrial scale.

TABLE 1
Thermodynamic and crystallographic properties
of the three anhydrous CaCO₃ polymorph.¹¹⁻¹⁴

| | | Enthalpy of | Gibbs Free | |
|---|---|---|---|---|
| | | Transition | Energy of | Solubility |
| | | to Calcite | Transition | Product in |
| | | at 25° C. | at 25° C. | water at 25° |
| CaCO₃ | Crystal | (ΔHₜᵣₛ) | (ΔGₜᵣₛ) | C. (Kₛₚ) |
| Polymorph | Structure | (kJ/mol) | (kJ/mol) | [×10⁹ M²] |
| Calcite | Rhombohedric | — | — | 3.31 |
| Aragonite | Orthorhombic | 0.44 | −0.84 | 4.61 |
| Vaterite | Hexagonal | −3.40 | −2.90 | 12.22 |

The stabilization of vaterite at near ambient conditions has been achieved in two primary ways:
1. Mixing highly soluble calcium and carbonate bearing species (e.g., CaCl₂), NaHCO₃, and Na₂CO₃) at precise molar ratios under a specific operating pH, initial saturation index, temperature, pressure, and mixing conditions.¹⁵⁻¹⁸
2. Introducing vaterite forming or calcite inhibiting additives (e.g., Mg-bearing species, sucrose, alcohols, and ammonium salts) into the solution.^{6,16,19-21}

At high reactant concentrations (>30 mmol/L Ca), the first method promotes calcite formation requiring additives to prevent the dissolution of vaterite and its subsequent recrystallization to calcite, the most thermodynamically stable CaCO₃ polymorph at ambient conditions.¹⁵ Similar results were also observed using a CO₂ bubbling method with a calcium hydroxide (Ca(OH)₂) slurry.^{22,23} Previous studies investigating this synthesis method in the presence of a known vaterite forming additive (i.e., sugar and ethanol) have predominantly produced calcite or a mixture of calcite, aragonite, and vaterite.^{23,24} Successful synthesis of high purity vaterite using this method have been largely demonstrated using various amino acids and amines.^{19,25,26} Utilization of acids presents several drawbacks as it neutralizes hydroxyl ions thereby reducing the rate of CO₂ absorption, Ca(OH)₂ dissolution and the overall rate of carbonation. Moreover, its active role in the reaction may produce unwanted by-products or increase the complexity of separation rendering the additive a consumable of the process.

The difficulty in synthesis using this method arises from a variety of factors which includes the marginal solubility of both CO₂ and Ca(OH)₂ (“CH”), and the transient reaction condition. As carbonation proceeds, the calcium concentration and pH decrease. The reduction in pH changes the relative abundance of the aqueous inorganic carbon species (i.e., CO₃²⁻ and HCO₃⁻) reducing the rate of CO₂ absorption, the concentration of CO₃²⁻ and, the favorability of vaterite precipitation. Therefore, to maximize CO₂ absorption and the supersaturation that may favor vaterite precipitation, it would be advantageous to operate without reducing the initial pH (~12) of the process. Furthermore, careful selection of the vaterite forming additive is necessary to increase the stability of vaterite in solution.

To overcome the partial neutralization of the amino acids and limited solubility of the reactants without sacrificing the vaterite promoting property of amines, another proposed strategy was to separate dissolution and carbonation. The process first transforms the precursor lime (CaO) slurry and NH₄Cl into CaCl₂) and NH₄OH prior to the carbonation step. Thereafter, the aqueous (i.e., NH₄Cl) and gas phase (i.e., HCl and NH₃) additives were recovered in two separation steps.⁶ Although the above-mentioned process is effective, the added steps increase complexity and produces toxic gases that can potentially limit its applicability.

Therefore, there remains a need for a process for producing CaCO₃ mixtures with a high proportion of the vaterite polymorph in a cost effective and energy efficient manner.

### SUMMARY OF THE INVENTION

The present disclosure provides, in various aspects, methods of preparing a vaterite product, comprising:
a) combining a calcium source, water, and at least one additive to produce a calcium rich solution or slurry;
b) carbonating the calcium rich solution or slurry with a gaseous carbon dioxide source, thereby forming a carbonation product mixture;
c) separating the carbonation product mixture to provide a wet vaterite mixture, and an additive mixture comprising water and the at least one additive; and
d) drying the wet vaterite mixture to produce the dry vaterite product.

The present disclosure further provides, in some aspects, systems for preparing a vaterite product, comprising:
a carbonation reactor, the carbonation reactor having a calcium-based solute slurry inlet, a carbon dioxide gas inlet in fluid communication with a carbon dioxide gas source, an additive inlet, and a carbonation product outlet;
a first separator, the first separator having a carbonation product mixture inlet, a wet CaCO₃ product outlet, and a water and additives mixture outlet, wherein the carbonation product mixture outlet from the carbonation reactor is coupled to the carbonation product mixture inlet;
a drying unit, the drying unit having a wet CaCO₃ product mixture inlet, a dry CaCO₃ product mixture outlet, and a volatile components outlet, wherein the wet CaCO₃ product mixture outlet from the first separator is coupled to the wet CaCO₃ product mixture inlet.

In certain aspects, the present disclosure provides systems for preparing a vaterite product, comprising:
a carbonation reactor configured to carbonate a calcium rich solution or slurry comprising a calcium source, water, and at least one additive with a gaseous carbon dioxide source to form a carbonation product mixture, the carbonation reactor having a calcium-based solute slurry inlet, a carbon dioxide source feed inlet in fluid communication with a gaseous carbon dioxide source, an additive inlet, and a carbonation product mixture outlet;
a first separator configured to separate the carbonation product mixture to provide a wet CaCO₃ mixture, and an additive mixture comprising water and the at least one additive, the first separator having a carbonation product mixture inlet, a wet CaCO₃ product outlet, and an additives mixture outlet, wherein the carbonation product mixture outlet of the carbonation reactor is coupled to the carbonation product mixture inlet;
a drying unit configured to dry the wet CaCO₃ mixture to produce a CaCO₃ product, the drying unit having a wet CaCO₃ product mixture inlet, a dry CaCO₃ product mixture outlet, and a volatile components outlet, wherein the wet CaCO₃ product mixture outlet of the first separator is coupled to the wet CaCO₃ product mixture inlet.

The present methods in some embodiments produce vaterite products having a relatively high proportion of vaterite compared to calcite and or aragonite.

In some aspects, provided herein are calcium carbonate compositions comprising from about 40 wt % to about 100 wt % vaterite, from 0 to about 40 wt % calcium hydroxide, and less than 50 wt % calcite.

### BRIEF DESCRIPTION OF THE DRAWINGS

FIG. 1 is a general block flow diagram of an embodiment of the vaterite production processes provided herein.

FIG. 2 is a general overview of the experimental setup and procedure of the mineral carbonation experiments.

FIG. 3 shows representative curves of the CO₂ concentration in the gas feed stream prior to the start of carbonation.

FIGS. 4A-4B show representative curves of the evolution of (a) conductivity, and (b) pH for an additive mass fraction, mᵢ, of 0.80 as a function of reaction time.

FIGS. 5A-5C show FTIR patterns of the carbonated products at varying additive mass fractions of (a) methanol (MeOH), (b) ethanol (EtOH), and (c) isopropanol (IPA). The green curve at the bottom of each graph is the FTIR pattern for the respective additive. The marked peaks in the graphs denote the characteristic peak of a given mineral. P=portlandite (i.e., Ca(OH)₂); V=vaterite; and C=calcite.

FIGS. 6A-6B show the calculated vaterite yield and selectivity using Eqs. 2 and 3 (a); and the CH conversion using Eq. 1 (b).

FIGS. 7A-7B show FTIR patterns of the carbonated products (a) with increasing additive mass fraction. (b) The resulting FTIR patterns at various carbonation times using a solution consisting of 5 mass % of sucrose.

FIGS. 8A-8B show the change in (a) vaterite and (b) unreacted CH composition in the carbonated particulate as a function of the initial IPA (mᵢₚₐ) and CH([CH]) concentration of the solution. The solubility limit of CH in water and the amount excess of that limit are denoted in the figure as dotted lines with a corresponding multiplies (i.e., 2× indicates a CH concentration that is twice that of the solubility limit of CH in water).

FIG. 9 shows the vaterite composition of the carbonated particulates as a function of the gas stream CO₂ ([CO₂]) concentration and IPA concentration of the solution.

FIGS. 10A-10B show the (a)diffraction patterns and (b) phase composition based on QXRD of the carbonated particulates produced using only monosodium glutamate (MSG) and an MSG-IPA additive mixture. The peaks corresponding to vaterite (“V”) and calcite (“C”) are denoted.

FIG. 11 is a general block flow diagram of an embodiment of the vaterite production processes provided herein, demonstrating the use of multiple additives.

FIG. 12 shows representative curves of the CO₂ concentration in the gas feed stream prior to the start of carbonation for several embodiments of the processes described herein.

### DETAILED DESCRIPTION OF THE INVENTION

### Methods for Producing Vaterite Products

The methods described herein advantageously reduce the process complexity for producing vaterite using a three phase (gas-solid-liquid) single-step synthesis method that produces CaCO₃ that consists of greater than or equal to 40 wt. % vaterite at near ambient operating conditions (19≤T (° C.)≤30 and P=0.01325 MPa) using one or more additives that reduce the surface tension and/or increase the viscosity (e.g., alcohols and sugars) of the solution.

The present disclosure provides, in various aspects, methods of preparing a vaterite product, comprising:
a) combining a calcium source, water, and at least one additive to produce a calcium rich solution or slurry;
b) carbonating the calcium rich solution or slurry with a gaseous carbon dioxide source, thereby forming a carbonation product mixture;
c) separating the carbonation product mixture to provide a wet vaterite mixture, and an additive mixture comprising water and the at least one additive; and
d) drying the wet vaterite mixture to produce the dry vaterite product.

In some embodiments, the method comprises:
a) combining calcium hydroxide, water, and an additive to produce a slurry;
b) carbonating the calcium hydroxide slurry with a gaseous carbon dioxide source, thereby forming a carbonation product mixture;
c) separating the carbonation product mixture to provide a wet vaterite mixture, and an additive mixture comprising water and the additive; and
d) drying the wet vaterite mixture to produce the vaterite product.

In certain embodiments, the method mineralizes CO₂ from a CO₂ feed source comprising from about 2% to about 100 vol. % CO₂. In some embodiments, the calcium source comprises calcium hydroxide (“CH”) (also known as slaked lime, portlandite and hydrated lime). In certain embodiments, the calcium source comprises an alkaline calcium feedstock. In various embodiments, a broad range of alkaline Ca-sources may be used, including waste brines, natural brines, Ca-rich natural rocks and minerals, and industrial wastes such as slags and fly ashes, etc.) could be used. In certain embodiments, a Ca source material comprising Ca, but which is not necessarily alkaline, may be used in combination with an alkaline source comprising an alkaline (basic) material (e.g., wherein the Ca source and the alkaline source are different sources). For example: waste brines, natural brines, Ca-rich natural rocks and minerals, and industrial wastes such as slags and fly ashes, etc. may be used in combination with one or more alkaline sources comprising an alkaline material. In some embodiments, the carbon dioxide feed stream comprises about 2%≤[CO₂]≤40 vol. %. In certain preferred embodiments, a carbon dioxide feed stream comprising about 0.5%≤[CO₂]≤95 vol. % is used.

In certain preferred embodiments, a stoichiometric excess of CO₂ may be used (provided via the gaseous carbon dioxide source) relative to the amount of calcium present in the calcium rich solution.

In some embodiments, the operating ratios of CH to CO₂ range from about 0.0001 to about 100,000 (mol/mol/min). In certain such embodiments, the operating ratios of CH to CO₂ range from about 0.001 to about 10,000 (mol/mol/min), or from about 0.01 to about 1,000 (mol/mol/min). In certain embodiments, the operating ratios of CH to CO₂ range from 0.1-100 (mol/mol/min). In certain embodiments, the operating ratios are between about 0.1 5 mol/mol/min.

Additives useful in the present methods include an alcohol, including a primary (e.g., methanol, ethanol, and propanol), secondary (e.g., 2-propanol, 2-butanol, and 3-pentanol) or tertiary (e.g., 2-methyl-2-propanol and 2-methyl-2-butanol) alcohol. In some embodiments, the additive is glycerin. In other embodiments, the additive is a mono-, di- or poly-saccharide, preferably sucrose. In other embodiments, the additive is an amino acid, or a salt thereof. In certain preferred embodiments, the at least one additive comprises monosodium glutamate (MSG). In some preferred embodiments, the at least one additive is MSG. In still further embodiments, the additive is polyethylene glycol. In some embodiments, the at least one additive is an amino acid, or a salt thereof, and an alcohol. In certain embodiments, the at least one additive is MSG and isopropanol.

The additive and water mixture (on a mass fraction basis) may range from 0.01 to 0.98 with preferential operation varying as a function of the additive. For additives with a surface tension and viscosity lower and higher, respectively, than water (at 20° C., the viscosity and surface tension of water is 1 mPa s and 72.75 mN/m, respectively), the preferential operating additive mass fraction (mᵢ) range is 0.10-0.80. For additives possessing a lower surface tension and a lower or comparable viscosity to water, the preferential additive mass fraction operating range may shift from 0.50-0.90. For solids and additives with comparable or lower surface tension and a greater viscosity than water, the preferential additive mass fraction range may shift to ≤0.10.

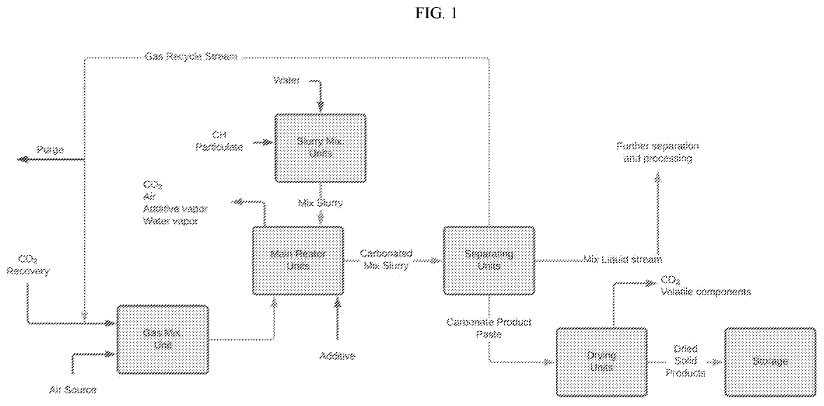

A block flow diagram of an embodiment of the present methods is shown in FIG. 1. A CH slurry and additive stream, having an initial pH≥11, are introduced into the carbonation reactor. The carbonation reactor contains a three-phase system comprising gaseous CO₂, liquid solvents, and solid particulates. While not being bound by theory, the reactor configuration may allow for the incorporation and accelerated dissociation of CO₂ into a calcium hydroxide bearing solution phase thereby facilitating the subsequent nucleation of calcium carbonate nuclei. In some embodiments, the reactor may be a semi-batch system while in other embodiments, the reactor may be a flow through continuous reactor.

In semi-batch configurations, the residence time of CO₂ in the carbon dioxide feed stream at standard conditions may range from 0.1 minutes-200 minutes. In continuous systems, operating liquid residence times range between 1 minute-30 minutes. In certain preferred embodiments, operating liquid residence times are greater than about 3 minutes (e.g., from 3 minutes to about 30 minutes). Additionally, in certain embodiments, the operating residence time of CO₂ in the gas feed is from about 0.1 minutes-200 minutes. In preferred embodiments, the operating residence time of CO₂ in the gas feed is less than about 18 minutes (e.g., from 1 minute to about 18 minutes).

The CO₂ rich gas stream that is bubbled into the mixture may or may not have undergone prior treatment to remove pollutants that may cause unwanted side reactions. The outlet stream of the reactor enters a series of separators to retrieve the solid particulates. The first separator unit removes the CaCO₃ solid from the additive-bearing liquid phase mixture while providing full or partial de-gassing of the carbonated solution. In some embodiments, the additive and water are further separated and can be recycled back into the process. Thereafter, the solids are dried in a drying unit prior to storage or further mechanical processing.

### Systems for Producing Vaterite Products

In certain aspects, the present disclosure provides systems for preparing a vaterite product, comprising:
a carbonation reactor configured to carbonate a calcium rich solution or slurry comprising a calcium source, water, and at least one additive with a gaseous carbon dioxide source to form a carbonation product mixture, the carbonation reactor having a calcium-based solute slurry inlet, a carbon dioxide source feed inlet in fluid communication with a gaseous carbon dioxide source, an additive inlet, and a carbonation product mixture outlet;
a first separator configured to separate the carbonation product mixture to provide a wet CaCO₃ mixture, and an additive mixture comprising water and the at least one additive, the first separator having a carbonation product mixture inlet, a wet CaCO₃ product outlet, and an additives mixture outlet, wherein the carbonation product mixture outlet of the carbonation reactor is coupled to the carbonation product mixture inlet;
a drying unit configured to dry the wet CaCO₃ mixture to produce a CaCO₃ product, the drying unit having a wet CaCO₃ product mixture inlet, a dry CaCO₃ product mixture outlet, and a volatile components outlet, wherein the wet CaCO₃ product mixture outlet of the first separator is coupled to the wet CaCO₃ product mixture inlet.

In certain embodiments, the system further comprises a mixer having a calcium source inlet, a water inlet, and a calcium hydroxide slurry outlet coupled to the calcium-based solute slurry inlet of the carbonation reactor.

In some embodiments, the system further comprises a second separator, the second separator having an additive mixture inlet, a water outlet, and an additive outlet, wherein the additive mixture outlet from the first separator is coupled to the additive mixture inlet of the second separator, and the second separator is configured to separate the at least one additive from the additive mixture.

In certain embodiments, the mixer is configured to mix water and one or more calcium sources to form the calcium rich solution or slurry.

In some embodiments, the additive inlet is adapted to receive at least one additive selected from an alcohol, an amino acid or a salt thereof, a saccharide, a polyethylene glycol, and a combination thereof.

### Vaterite Compositions

In certain aspects, provided herein are calcium carbonate compositions comprising from about 40 wt % to about 100 wt % vaterite, from 0 to about 40 wt % calcium hydroxide, and less than 50 wt % calcite.

In certain embodiments, the composition comprises from about 45 wt % to about 85 wt % vaterite. In some embodiments, the composition comprises from 0 wt % to about 10 wt % calcite. In certain embodiments, the composition comprises from about 1 wt % to about 8 wt % calcite.

In some embodiments, the composition comprises from about 1 wt % to about 20 wt % calcium hydroxide.

In certain embodiments, the composition comprises at least one additive selected from an alcohol, an amino acid, or a salt thereof, a saccharide, a polyethylene glycol, and a combination thereof, preferably wherein the composition comprises less than 1.0 mass percent of the at least one additive.

In some embodiments, the at least one additive is isopropanol.

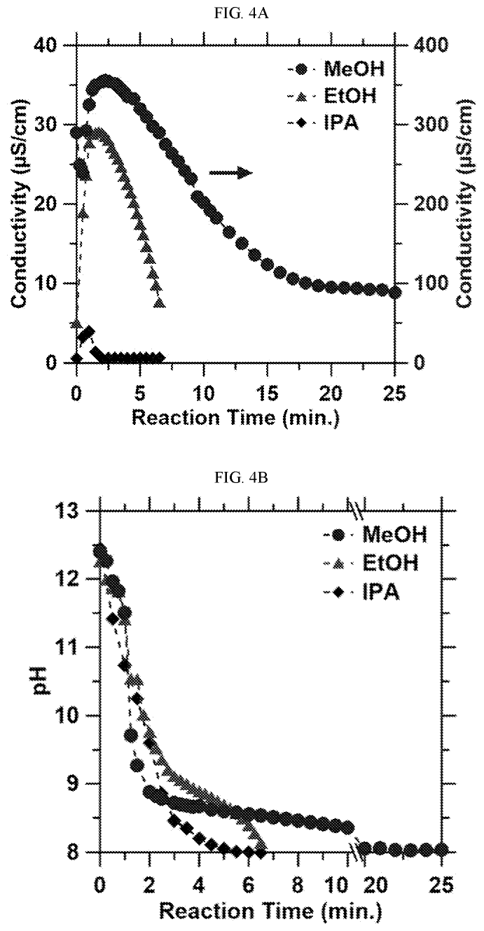

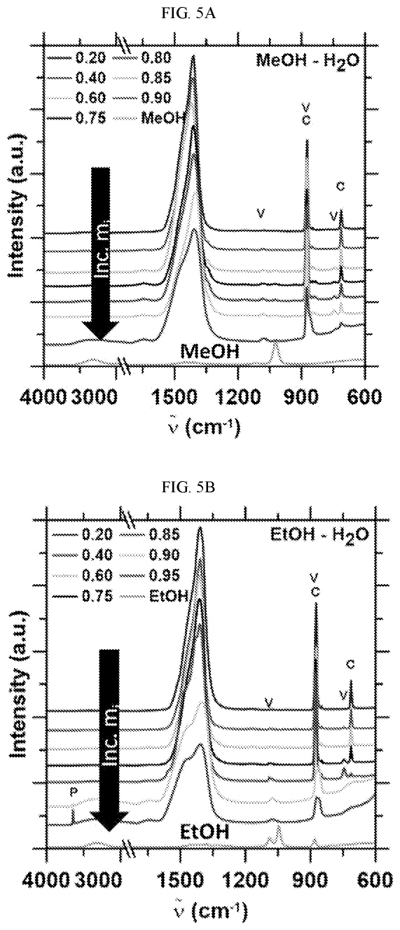

In certain embodiments, the composition gives an X-Ray diffraction pattern according to FIG. 4b, and wherein the X-Ray diffraction patterns were acquired using Panalytical X'Pert Pro X-ray Powder Diffractometer (Cu Kα radiation of 1.5410 Å) with a scanning range of 5°-70° and a scan rate with an integrated step scan of 0.021° (20).

### Definitions

Unless otherwise defined herein, scientific and technical terms used in this application shall have the meanings that are commonly understood by those of ordinary skill in the art.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not.

“Carbonation” as used herein refers to any reaction of a compound or material with CO₂ to form carbon-containing products including, as a non-limiting example, the carbonation of Ca(OH)₂ with CO₂ to form calcium carbonate, CaCO₃.

Certain ranges are presented herein with numerical values being preceded by the term “about.” As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

The term “residence time” as used herein refers to the mean residence time of the specified component species (e.g., the residence time of CO₂ in the carbon dioxide feed stream). The “residence times” described herein are equal to the quotient obtained by dividing the reactor volume by the volumetric flow rate.

### EXAMPLES

### Example 1

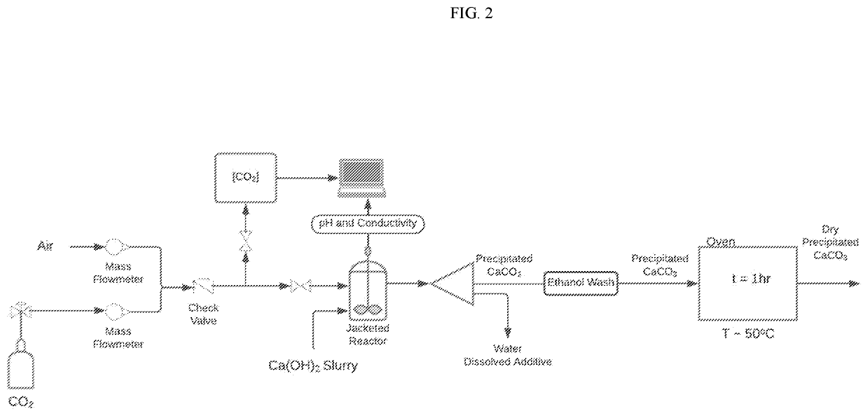

To assess the feasibility of the proposed vaterite synthesis approach, a series of carbonation experiments were conducted using one of the following additives: methanol “MeOH” (CH₂O), ethanol “EtOH” (C₂H₅O), 2-propanol “IPA” (C₃H₈O). The additive mass fraction (mᵢ) in the mixed water/additive solution was varied from 0.20-0.90. Additionally, comparative experiments were carried out using IPA, glycerol, polyethylene glycol (PEG) 200, PEG 20,000 and sucrose. All the chemicals that were used in the experiments were chemical grade with the exception of the 200-proof ethanol (USP; Decal Labs) and Ca(OH)₂ (≥90 wt. % purity as determined by thermogravimetric analysis). The experiments were conducted in a non-adiabatic semi-batch system at ambient temperatures (T=19° C.−26° C.) and pressure using a 500 mL closed lid glass reactor. The inlet gas stream was split across the diameter of the reactor and a magnetic stirrer was operated at 700 rpm during carbonation. A bypass stream was included to monitor the CO₂ concentration of the inlet gas stream as shown in FIG. 2.

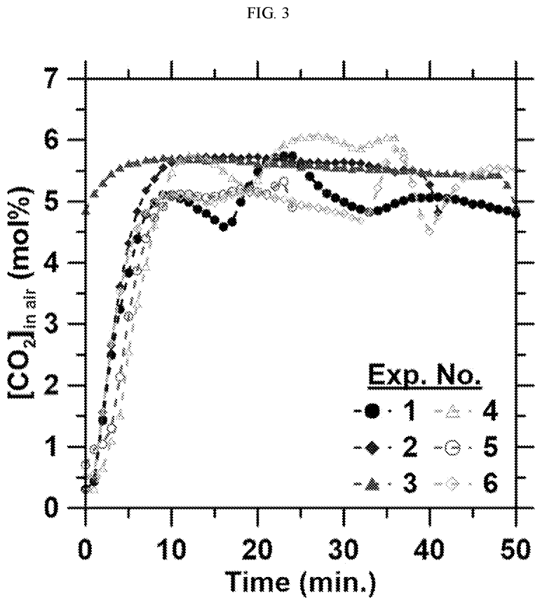

Prior to the start of carbonation, the system CO₂ concentration was measured as shown in the representative curves of FIGS. 3a and b). During the carbonation experiments, the pH and conductivity were recorded, and the reaction was terminated once a pH of 8 was reached. Once this termination condition was reached, the solution was vacuum filtered using a 0.22 μm membrane filter and washed with 200 proof ethanol. The filtered CaCO₃ products were immediately analyzed using attenuated total reflectance Fourier transform infrared (ATR-FTIR: Spectrum Two FT-IR Spectrometer, Perkin Elmer) and placed into an oven (T~50° C.) for an hour to dry. Table 2 shows the characteristic peak locations of the four vibrational modes of the carbonate group of each anhydrous CaCO₃ polymorph. Due to the large overlap of the absorption bands, the vibrational mode,v4, (refer to Table 2) was used as the initial qualitative identifier of the CaCO₃ polymorph. After approximately one hour of oven drying, the dried powders were further characterized using FTIR to assess the influence of the drying step, thermogravimetric analysis (TGA: STA 8000, Perkin Elmer) to determine the portlandite conversion and X-ray diffraction (XRD) to identify the mineral phases present. XRD analysis was performed using a Panalytical X'Pert Pro X-ray Powder Diffractometer (Cu Kα radiation of 1.5410 Å) with a scanning range of 5°-70° and a scan rate with an integrated step scan of 0.021° (20).

TABLE 2
The characteristic FTIR peaks for the
three anhydrous polymorphs.^{11,27,28}

| CaCO₃ | ν₁ | ν₂ | ν₃ | ν₄ |
|---|---|---|---|---|
| Polymorph | (cm⁻¹) | (cm⁻¹) | (cm⁻¹) | (cm⁻¹) |
| Vaterite | ~1087 | ~875 | ~1490 and ~1440 | ~745 |
| Aragonite | ~1082 | ~856 | ~1490 | ~713 and ~700 |
| Calcite | — | ~875 | ~1420 | ~713 |

BGMN—Rietveld refinement was applied on the XRD patterns using the Profex software to identify and quantify (QXRD) the mineral phases present.²⁹ The following phases were identified in the resulting XRD patterns: portlandite (PDF #04-010-3117), calcite (PDF #04-008-0788), and vaterite (COD #9015898). For the thermogravimetric analysis, roughly 25 mg of sample was placed in a pure aluminum oxide crucible and heated at a rate of 15° C./min over a temperature range of 35° C. to 975° C. under UHP-N₂ gas purge at a flow rate of 20 mL/min. The mass loss at the temperature range between 360-550° C. and 550-900° C. were associated with portlandite and calcium carbonate decomposition, respectively.³⁰ The solid conversion of portlandite (X_{CH}) was calculated using the mass of CH in the feed

$$( {m}_{o}^{p} )$$

and carbonated samples

$$( {m}_{f}^{p} )$$

as shown below.

$${X}_{CH} = \frac{{m}_{o}^{p} - {m}_{f}^{p}}{{m}_{o}^{p}} \times 100 \qquad Eq . 1$$

The vaterite yield (\tilde{Y}ᵥ) and selectivity (\tilde{S}ᵥ), were calculated using the mass of each mineral phases based on QXRD and TGA results and the following equations:

$${\tilde{Y}}_{v} = \frac{{m}_{f}^{v}}{{m}_{o}^{p}} \times 100 = \frac{{\tilde{s}}_{v}}{100} \times {X}_{CH} \qquad Eq . 2$$

$${\tilde{s}}_{v} = \frac{{m}_{f}^{v}}{{m}_{o}^{p} - {m}_{f}^{p}} \times 100 \qquad Eq . 3$$

Where,

$${m}_{f}^{i} and {m}_{o}^{i}$$

corresponds to the final and initial mass compositions of mineral phase i. The superscripts v and p denote vaterite, and portlandite, respectively. The [symbol] shows the vaterite wt. % relative to the inlet CH whereas the \tilde{S}ᵥ indicate the amount of vaterite produced relative to the reacted CH.

A CO₂ enriched gas stream was produced by mixing prescribed flowrates using two flowmeters (Brooks Instrument: Sho-rate) of ultra-high purity CO₂ and compressed lab air. The carbonation experiments were carried out using a total inlet gas flowrate of 1500 sccm containing 5±1 mol % of CO₂ in air, and a 200 g calcium solution with 10 mmols of CH per kg of solution.

FIGS. 4a and 4b show the variation in conductivity and pH, respectively, across the three alcohols at a fixed mᵢ=0.80. Despite the greater molar fraction of MeOH owing to its lower molecular weight, a lower conductivity was observed with both the EtOH and IPA solutions. Considering the nonconductive property of these alcohols, the higher observed conductivity could indicate a greater ion activity within the MeOH solution. At a given mᵢ, the initial conductivity of each additive—H₂O was found to decrease with the additive molecular weight across the experimental mᵢ. The greater ion activity within the MeOH—H₂O system may stem from the lower predicted hydration shell and greater self-diffusivity of the MeOH molecule owing to its smaller accompanying alkyl group.^{31,32} In contrast, the larger alkyl group and non-terminating hydroxyl of the IPA enhances the hydrophobic effect (i.e., larger hydration shell) and provide steric hindrance to mitigate hydrogen bonding between IPA molecules (i.e., more effectively disrupt the hydrogen bonding network between water molecules).

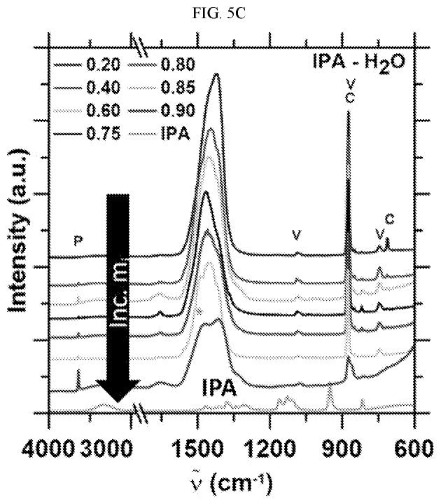

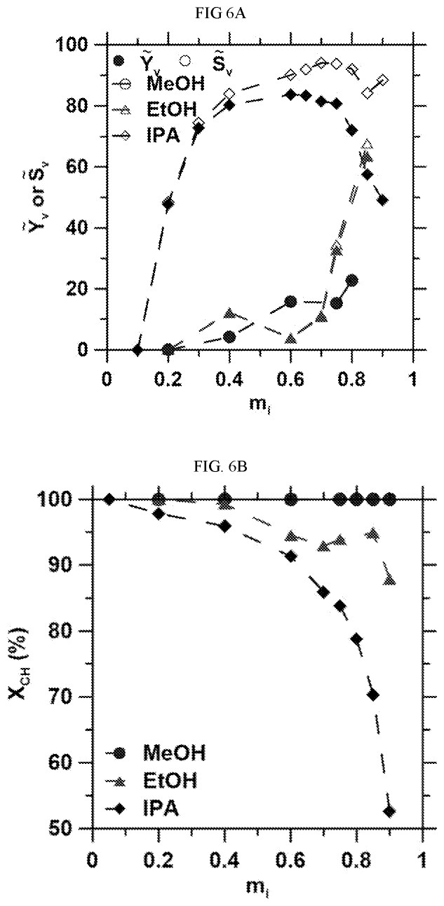

While not being bound by theory, the greater “structuring” ability of IPA appears to promote the formation of vaterite and inhibit calcite at the expense of X_{CH} (shown in FIG. 5c). This can also be seen in FIG. 6a, where an \tilde{S}ᵥ>80% was observed in the IPA-H₂O system for mᵢ>0.20. The lower corresponding \tilde{Y}ᵥ was a consequence of the reduced CH conversion (shown in FIG. 6b). On the other hand, the observed increase in vaterite formation with increasing MeOH and EtOH concentrations (shown in FIG. 6a) was likely due to the antisolvent property of alcohols as opposed to the macroscopic property of the solution (i.e., surface tension (σ) and viscosity (η)) as these lighter alcohols would be of a higher concentration on a molar basis than IPA. A decrease in the overall water concentration, reduces the frequency of CaCO₃ solvation thereby lowering the solubility of metastable CaCO₃. This can also be seen in the greater presence of ACC (shown in FIGS. 5a-c) when mᵢ=0.90.

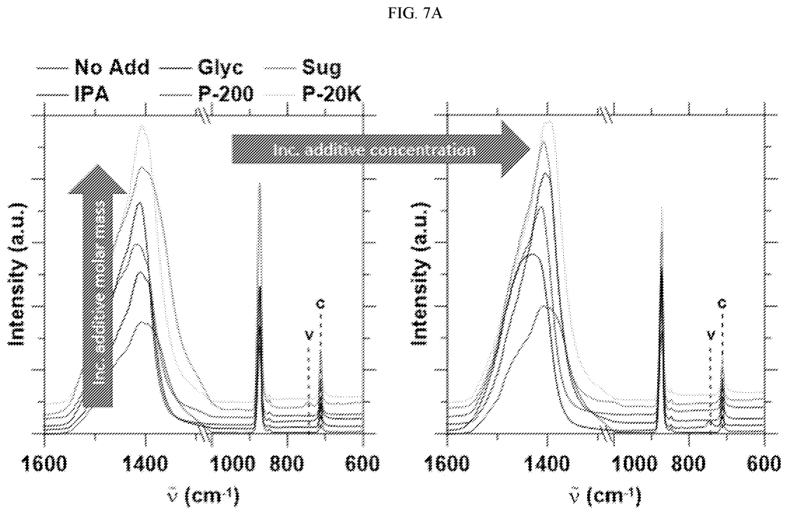

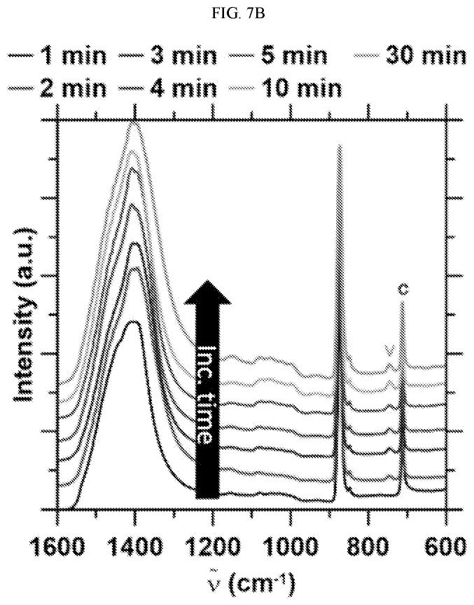

Carrying out the same experimental method using higher molecular weight additives (i.e., glycerol, sucrose, and two polyethylene glycols (PEG) with different average molecular weights (PEG m.w. 200 and PEG m.w. 20,000) primarily precipitated calcite. Vaterite precipitation was observed with 5 mass % sucrose and 20 mass % IPA (shown in FIG. 7a). To assess the stability of the precipitated vaterite in the sucrose solution, continuous carbonation was carried out for up to 30 minutes instead of ending the test after reaching pH 8. FIG. 7b shows the formation of the characteristic 745 cm-1 vaterite peak after one minute of carbonation and persistence even after 30 minutes indicating high stability despite the increase in contact time with the mother liquor.

The dominant precipitation of calcite when higher molecular weight additives were used may be due to the greater increase in viscosity without a significant reduction in surface tension. This would indicate a slower diffusion through the bulk volume intensifying the concentration gradient from the reaction front (i.e., CO₂ source) to the bulk solution. Moreover, the protracted diffusion timescales may increase the heterogeneity of the solution producing locally lower supersaturations that may favor calcite formation and even delay nucleation. In the 5 mass % sucrose solution, the observed vaterite formation, may be due to the negligible increase in the overall solution viscosity and the greater dehydrating ability of the sucrose molecule owing to its eight hydroxyls. The latter may also be the reason for the decreased solubility of vaterite in the dilute sucrose mixture.

The overall greater vaterite selectivity with the monohydric alcohols suggests that reducing the surface tension of the solution promotes vaterite precipitation. This may be attributed to the influence of this property on the bubble morphology. The Young-Laplace predicts a reduction in bubble size (i.e., greater surface area to volume ratio) with an increase in surface tension. This reduced bubble size may enhance the uniformity of the gas distribution in solution and favorably improve the liquid side mass transport (i.e., CO₂ solvation) of the gas—liquid interface.

Herein, repeatable vaterite precipitation was demonstrated at near ambient temperature and pressure using a CO₂ bubbling method and a calcium hydroxide slurry precursor. An array of fully miscible additives was used to modify the micro- and macroscopic properties of the initial mixture. The method exploits additives to promote spherulitic growth to favor the nucleation of higher energy CaCO₃ (i.e., amorphous calcium carbonate (ACC) to vaterite) by facilitating growth front nucleation and decreasing the solubility of vaterite. The proposed approach offers a fast and simple method that eases the scalability of vaterite production using a CO₂ rich gas stream. Industrial scale production of vaterite using a calcium hydroxide slurry precursor offers a CO₂ mineralizing capacity 0.59 g CO₂/g CH processed. The produced vaterite may be used as a partial (e.g., limestone cement) or full (i.e., CaCO₃—based cement) OPC replacement in concrete formulations or as a bio-compatible material for biomedical, food and other environmental applications.

### Example 2

The concurrent influence of the IPA mass fraction (m_{IPA}), initial Ca(OH)₂ concentration ([CH]) and gas stream CO₂ concentration in air ([CO₂]) on vaterite selectivity was assessed using the same experimental setup in Example 1. At a fixed total gas volumetric flowrate of 1500 sccm, carbonation was carried out using 2< [CO₂]<30 mol % (representative curves are shown in FIG. 2). Maintaining 200 g total solution, IPA mass fraction of the solution was varied from 0.30 to 0.87 g IPA/g solution and the initial CH concentration was varied from 21.41 to 78.59 mmol of CH/kg of water. The carbonation experiments were terminated when pH 8 was reached and the same post carbonation and characterization procedure was carried out. The carbonation experiments were carried out at initial temperatures of about 21 to about 27° C. with an average decrease in temperature of about 0.50° C. after carbonation. The slight variation in the initial temperature was caused by the heat released upon addition of IPA due to the negative enthalpy of mixing.

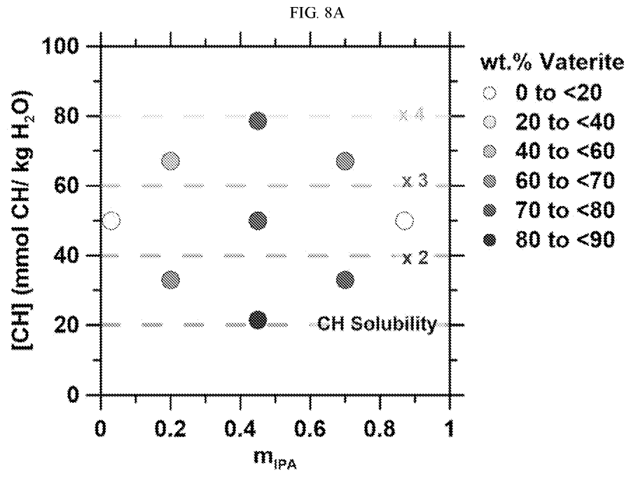

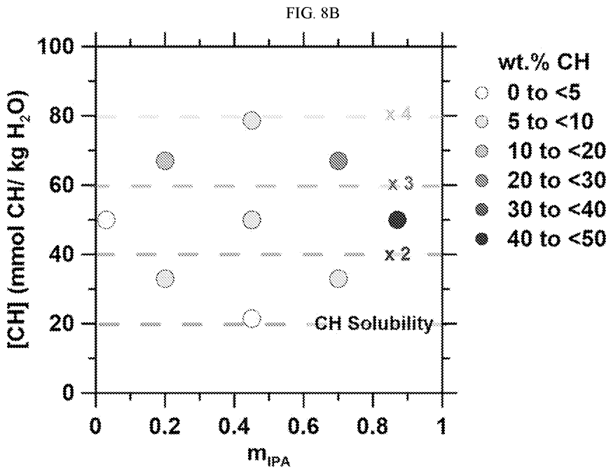

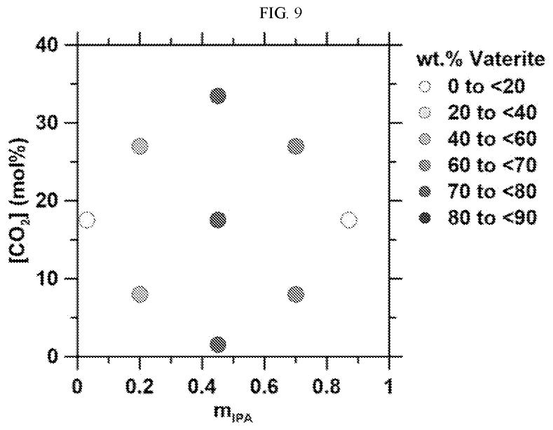

FIG. 8a shows that vaterite selectivity in this system is predominantly controlled by the operating m_{=IPA}. An increase in the initial [CH] of up to about four times of the solubility limit of CH in water, produced particulates with >70 wt. % vaterite. A decrease in vaterite composition with increasing [CH] was observed on account of the higher composition of the unreacted CH as shown in FIG. 8b. The CO₂ concentration in the inlet gas stream was found to have the weakest effect on vaterite selectivity as shown in FIG. 9.

### Example 3

Carbonation experiments were conductive using a semi-batch system with monosodium glutamate (MSG) and an MSG—IPA mix additive. An initial solution of roughly 250 g with a fixed 20 mmol CH/kg of water and a prescribed amount of MSG was prepared for each experiment. The amount of MSG added corresponded to the target [MSG]: [CH] molar ratio of the experiment (i.e., [MSG]: [CH] molar ratio of 1 and 2). For the mixed MSG—IPA case, the added mass of each component was adjusted to account for the lower water content (i.e., 20 mass % replacement of water with IPA). Carbonation was carried out using a gas volumetric flowrate of roughly 664 sccm and a calibrated 4.88 mol % CO₂ in N₂. Similar to Examples 1 and 2, carbonation was terminated when pH 8 was reached and the same post carbonation and characterization procedure was carried out.

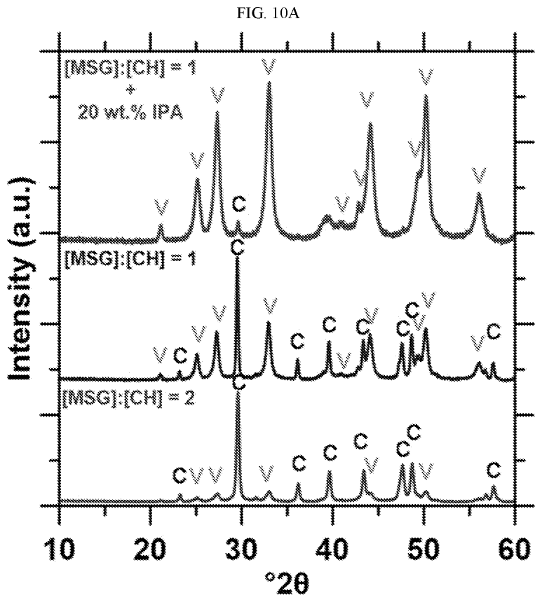

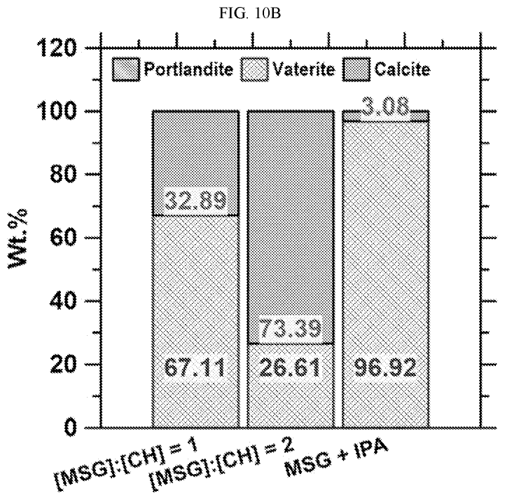

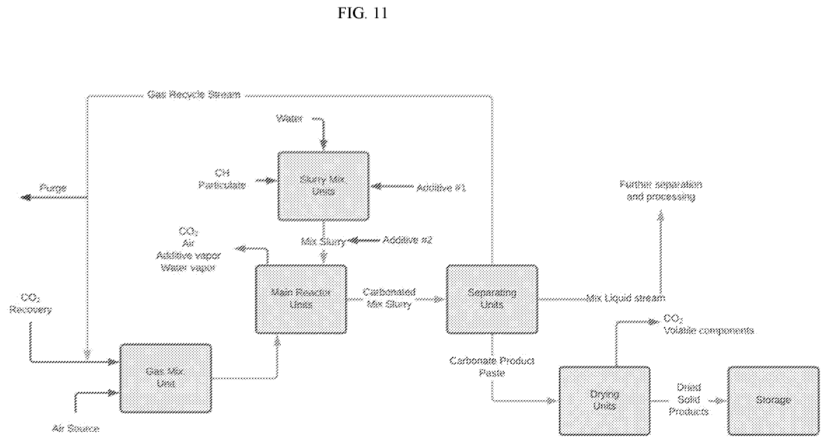

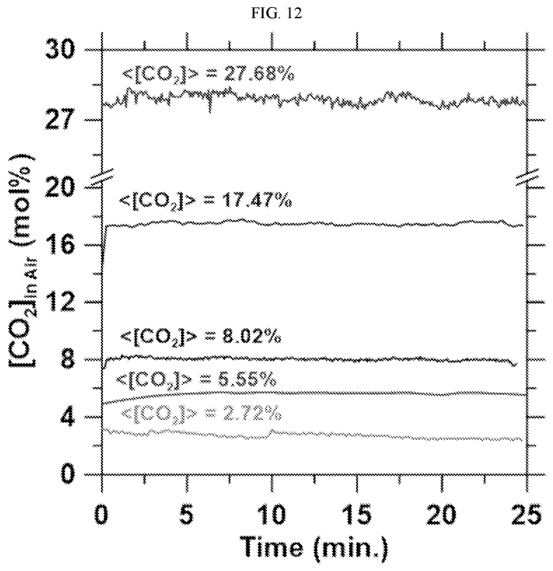

In consistency with the results from Matsushita et al., FIGS. 10a and 10b show that addition of equimolar concentration of MSG and CH, forms a mixture of vaterite and calcite.³³However, contradictory to the previous studies, FIG. 10b shows that an increase in MSG concentration favored calcite precipitation.^{33,34} This discrepancy may be attributed to the lower operating CO₂ concentration in this study. The lower CO₂ concentration in the gas feed reduces the partial pressure of gaseous CO₂, which decreases the corresponding aqueous CO₂ concentration.

Carbonating a solution with 20 wt. % IPA and an [MSG]:[CH]-1 greatly enhances the vaterite selectivity and reduces the required IPA input of the process. In comparison to the systems with only MSG or only IPA, FIG. 10b shows that the carbonated particulates consisted of 96 wt. % vaterite with the remainder being calcite as shown in FIG. 10a.

### Incorporation by Reference

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

### REFERENCES

(1) Epa. 2019 Direct Carbon Intensities Quartile Metric Ton CO 2/Metric Ton of Clinker Metric Ton CO 2/Metric Ton of Cement Carbon Intensity; 2021. https://www.epa.gov/system/files/documents/2021-10/cement-carbon-intensities-fact-sheet.pdf.
(2) Vass, T.; Levi, P.; Gout, A.; Mandová, H. Cement, IEA, Paris. https://www.iea.org/reports/cement.
(3) Andrew, R. M. Global CO₂ Emissions from Cement Production, 1928-2018. Earth Syst Sci Data 2019, 11 (4), 1675-1710. https://doi.org/10.5194/ESSD-11-1675-2019.
(4) U.S. Pat. No. 8,137,455—B1—Methods and Compositions Using Calcium Carbonate\Unified (4) Patents. https://portal.unifiedpatents.com/patents/patent/U.S. Pat. No. 8,137,455-B1.
(5) U.S. Pat. No. 9,133,581-B2—Non-cementitious Compositions Comprising Vaterite and Methods Thereof\Unified Patents. https://portal.unifiedpatents.com/patents/patent/U.S. Pat. No. 9,133,581-B2.
(6) Hargis, C. W.; Chen, I. A.; Devenney, M.; Fernandez, M. J.; Gilliam, R. J.; Thatcher, R. P. Calcium Carbonate Cement: A Carbon Capture, Utilization, and Storage (CCUS) Technique. Materials 2021, Vol. 14, Page 2709 2021, 14 (11), 2709. https://doi.org/10.3390/MA14112709.
(7) Rodriguez-Navarro, C.; Suzuki, A.; Ruiz-Agudo, E. Alcohol Dispersions of Calcium Hydroxide Nanoparticles for Stone Conservation. Langmuir 2013, 29 (36), 11457-11470. https://doi.org/10.1021/LA4017728.
(8) Nakano, K.; Mito, S.; Xue, Z. Self-Sealing of Wellbore Cement under the CO₂ Batch Experiment Using Well Composite Sample. Energy Procedia 2017, 114, 5212-5218. https://doi.org/10.1016/J.EGYPRO.2017.03.1677.
(9) Boyjoo, Y.; Pareek, V. K.; Liu, J. Synthesis of Micro and Nano-Sized Calcium Carbonate Particles and Their Applications. 2014. https://doi.org/10.1039/c4ta02070 g.
(10) Song, X.; Cao, Y.; Bu, X.; Luo, X. Porous Vaterite and Cubic Calcite Aggregated Calcium Carbonate Obtained from Steamed Ammonia Liquid Waste for Cu2+ Heavy Metal Ions Removal by Adsorption Process. Appl Surf Sci 2021, 536, 147958. https://doi.org/10.1016/J.APSUSC.2020.147958.
(11) al Omari, M. M. H.; Rashid, I. S.; Qinna, N. A.; Jaber, A. M.; Badwan, A. A. Calcium Carbonate. Profiles Drug Subst Excip Relat Methodol 2016, 41, 31-132. https://doi.org/10.1016/BS.PODRM.2015.11.003.
(12) Gal, J. Y.; Bollinger, J. C.; Tolosa, H.; Gache, N. Calcium Carbonate Solubility: A Reappraisal of Scale Formation and Inhibition. Talanta 1996, 43 (9), 1497-1509. https://doi.org/10.1016/0039-9140 (96) 01925-X.
(13) Wolf, G.; Lerchner, J.; Schmidt, H.; Gamsjager, H.; Konigsberger, E.; Schmidt, P. Thermodynamics of CaCO₃ Phase Transitions. Journal of Thermal Analysis 1996, 46, 353-359.
(14) Wolf, G.; Königsberger, E.; Schmidt, H. G.; Königsberger, L.-C.; Gamsjäger, H. Thermodynamic Aspects of the Vaterite-Calcite Phase Transition. J Therm Anal calorim 2000, 60, 463-472.
(15) Ogino, T.; Suzuki, T.; Sawada, K. The Formation and Transformation Mechanism of Calcium Carbonate in Water. Geochim Cosmochim Acta 1987, 51 (10), 2757-2767. https://doi.org/10.1016/0016-7037 (87) 90155-4.
(16) Konopacka-Łyskawa, D. Synthesis Methods and Favorable Conditions for Spherical Vaterite Precipitation: A Review. Crystals (Basel) 2019, 9 (4). https://doi.org/10.3390/CRYST9040223.
(17) Ševčík, R.; Pérez-Estébanez, M.; Viani, A.; Šašek, P.; Mácová, P. Characterization of Vaterite Synthesized at Various Temperatures and Stirring Velocities without Use of Additives. Powder Technol 2015, 284, 265-271. https://doi.org/10.1016/J.POWTEC.2015.06.064.
(18) Tai, C. Y.; Chen, F.-B. Polymorphism of CaCO, Precipitated in a Constant-Composition Environment.
(19) Chuajiw, W.; Takatori, K.; Igarashi, T.; Hara, H.; Fukushima, Y. The Influence of Aliphatic Amines, Diamines, and Amino Acids on the Polymorph of Calcium Carbonate Precipitated by the Introduction of Carbon Dioxide Gas into Calcium Hydroxide Aqueous Suspensions. 2013. https://doi.org/10.1016/j.jcrysgro.2013.10.009.
(20) Lin, Y.; Hu, Q.; Chen, J.; Ji, J.; Henry Teng, H. Formation of Metastable CaCO₃ Polymorphs in the Presence of Oxides and Silicates. Cryst Growth Des 2009, 9 (11), 4634-4641. https://doi.org/10.1021/cg900085e.
(21) Konopacka-Łyskawa, D.; Czaplicka, N.; Kościelska, B.; Łapiński, M.; Gębicki, J. Influence of Selected Saccharides on the Precipitation of Calcium-Vaterite Mixtures by the CO 2 Bubbling Method. Crystals (Basel) 2019, 9 (2). https://doi.org/10.3390/cryst9020117.
(22) Munawaroh, F.; Khamsatul Muharrami, L.; Arifin, Z. The Effect of CO₂ Gas Flow Rate on Precipitated CaCO3 Formed at Room Temperature. 2014, 30018. https://doi.org/10.1063/1.5054513.
(23) Jimoh, O. A.; Otitoju, T. A.; Hussin, H.; Ariffin, K. S.; Baharun, N. Understanding the Precipitated Calcium Carbonate (PCC) Production Mechanism and Its Characteristics in the Liquid-Gas System Using Milk of Lime (MOL) Suspension. South African Journal of Chemistry 2017, 70, 1-7. https://doi.org/10.17159/0379-4350/2017/v70a1.
(24) Seo, K. S.; Han, C.; Wee, J. H.; Park, J. K.; Ahn, J. W. Synthesis of Calcium Carbonate in a Pure Ethanol and Aqueous Ethanol Solution as the Solvent. J Cryst Growth 2005, 276 (3-4), 680-687. https://doi.org/10.1016/J.JCRYSGRO.2004.11.416.
(25) Luo, J.; Kong, F.; Ma, X. Role of Aspartic Acid in the Synthesis of Spherical Vaterite by the Ca(OH)₂—CO 2 Reaction. 2015. https://doi.org/10.1021/acs.cgd.5b01333.
(26) Chuajiw, W.; Nakano, M.; Takatori, K.; Kojima, T.; Wakimoto, Y.; Fukushima, Y. Effects of Amine, Amine Salt and Amide on the Behaviour of Carbon Dioxide Absorption into Calcium Hydroxide Suspension to Precipitate Calcium Carbonate. J Environ Sci (China) 2013, 25 (12), 2507-2515. https://doi.org/10.1016/S1001-0742 (12) 60284-8.
(27) Xu, B.; Poduska, K. M. Linking Crystal Structure with Temperature-Sensitive Vibrational Modes in Calcium Carbonate Minerals. Physical Chemistry Chemical Physics 2014, 16 (33), 17634-17639. https://doi.org/10.1039/c4cp01772b.
(28) Liu, R.; Huang, S.; Zhang, X.; Song, Y.; He, G.; Wang, Z.; Lian, B. Bio-Mineralisation, Characterization, and Stability of Calcium Carbonate Containing Organic Matter †. 2021. https://doi.org/10.1039/dlra00615k.
(29) Doebelin, N.; Kleeberg, R. Profex: A Graphical User Interface for the Rietveld Refinement Program BGMN. J. Appl. Cryst 2015, 48, 1573-1580. https://doi.org/10.1107/S1600576715014685.
(30) Lothenbach, B.; Durdziński, P.; De Weerdt, K. Thermogravimetric Analysis.
(31) Li, R.; Agostino, C. D. '; Mcgregor, J.; Mantle, M. D.; Zeitler, J. A.; Gladden, L. F. Mesoscopic Structuring and Dynamics of Alcohol/Water Solutions Probed by Terahertz Time-Domain Spectroscopy and Pulsed Field Gradient Nuclear Magnetic Resonance. J. Phys. Chem. B 2014, 118, 10156-10166. https://doi.org/10.1021/jp502799x.
(32) Klinov, A.; Anashkin, I. Diffusion in Binary Aqueous Solutions of Alcohols by Molecular Simulation. Processes 2019, 7 (12). https://doi.org/10.3390/PR7120947.
(33) Matsushita, I.; Hamada, Y.; Moriga, T.; Ashida, T.; Nakarayashi, I. Synthesis of Vaterite by Carbonation Process in Aqueous System.
(34) Saraya, M. E. S. I. Effect of L (+) Ascorbic Acid and Monosodium Glutamate Concentration on the Morphology of Calcium Carbonate. J Solid State Chem 2015, 231, 114-122. https://doi.org/10.1016/J.JSSC.2015.08.020.

We claim:

1. A method of preparing a vaterite product, comprising:
a) combining a calcium source, water, and at least one additive to produce a calcium rich solution or slurry;
b) carbonating the calcium rich solution or slurry with a gaseous carbon dioxide source, thereby forming a carbonation product mixture;
c) separating the carbonation product mixture to provide a wet vaterite mixture, and an additive mixture comprising water and the at least one additive; and
d) drying the wet vaterite mixture to produce the dry vaterite product.

2. The method of claim 1, wherein the calcium source comprises an alkaline Ca feedstock.

3. The method of claim 1 or 2, wherein the calcium source comprises calcium hydroxide.

4. The method of any one of claims 1-3, wherein the calcium source comprises Ca²⁺ ions.

5. The method of any one of claims 1-4, wherein the calcium source is or is derived from a waste brine, natural brine, Ca-rich rock, Ca-rich mineral, or industrial waste (e.g., a slag or a fly ash), or a combination thereof.

6. The method of any one of claims 1-5, combining a calcium source, water, and at least one additive to produce a calcium rich solution or slurry further comprises adding an alkaline source comprising a basic material to the calcium rich solution or slurry.

7. The method of any one of claims 1-6, wherein the gaseous carbon dioxide source comprises from about 0.02 vol % to about 100 vol % CO₂.

8. The method of any one of claims 1-7, wherein the gaseous carbon dioxide source comprises from about 0.02 vol % to about 40 vol % CO₂.

9. The method of any one of claims 1-8, wherein the gaseous carbon dioxide source comprises from about 0.02 vol % to about 10 vol % CO₂.

10. The method of any one of claims 1-9, wherein an operating ratio of the carbon dioxide to calcium is from about 0.0001 mol/mol/min to about 100,000 mol/mol/min.

11. The method of any one of claims 1-10, wherein an operating ratio of carbon dioxide to calcium is from about 0.1 mol/mol/min to about 5 mol/mol/min.

12. The method of any one of claims 1-11, wherein method is carried out in a carbonation reactor, and the carbonation reactor is a continuously stirred batch reactor or a flow-through reactor.

13. The method of any one of claims 1-12, wherein the gaseous carbon dioxide source comprises a flue gas.

14. The method of any one of claims 1-13, wherein carbonating the calcium rich solution or slurry comprises contacting the gaseous carbon dioxide source with the calcium rich solution or slurry in a carbonation reactor.

15. The method of claim 14, wherein contacting the gaseous carbon dioxide source with the calcium rich solution or slurry comprises bubbling the gaseous carbon dioxide source into the carbonation reactor.

16. The method of any one of claims 1-15, wherein step c) is conducted at a temperature of from about 10° C. to about 100° C.

17. The method of any one of claims 1-15, wherein step c) is conducted at a temperature of from about 19° C. to about 30° C.

18. The method of any one of claims 1-17, wherein step c) is conducted at a pressure of from about 0.01 to about 0.05 MPa.

19. The method of any one of claims 1-18, wherein step c) is from about 0.01 to about 0.02 MPa.

20. The method of any one of claims 1-19, wherein the at least one additives is selected from an alcohol, a saccharide, a polyethylene glycol, an amino acid or salt thereof, and any combination thereof combination thereof.

21. The method of claim 20, wherein the alcohol is selected from methanol, ethanol, propanol, 2-propanol, butanol, 3-pentanol, 2-methyl-2-propanol, 2-methyl-2-butanol, glycerin, and any combination thereof.

22. The method of claim 21, wherein the alcohol is 2-propanol.

23. The method of any one claims 20-22, wherein the saccharide is a mono-, di- or poly-saccharide.

24. The method of claim 23, wherein the saccharide is selected from sucrose, maltose, galactose, xylitol, sorbitol, and any combination thereof.

25. The method of any one of claims 20-24, wherein the amino acid is monosodium glutamate (MSG).

26. The method of any one of claims 20-25, wherein the at least one additive is 2-propanol and monosodium glutamate.

27. The method of any one of claims 1-26, wherein the calcium rich solution or slurry comprises the at least one additive and the water in a mass fraction of from about 0.01 to about 0.98.

28. The method of claim 27, wherein the mass fraction is from about 0.10 to about 0.80.

29. The method of claim 27, wherein the mass fraction is from about 0.50 to about 0.90.

30. The method of claim 27, wherein the mass fraction is from about 0.01 to about 0.30.

31. The method of any one of claims 1-30, wherein the method provides a conversion of calcium hydroxide to calcium carbonate (X_{ch}) of at least 50%.

32. The method of claim 31, wherein X_{ch} is at least 60%.

33. The method of claim 31, wherein X_{ch} is at least 70%.

34. The method of claim 31, wherein X_{ch} is at least 80%.

35. The method of claim 31, wherein X_{ch} is at least 90%.

36. The method of claim 31, wherein X_{ch} is at least 95%.

37. The method of any one of claims 31-36, wherein X_{ch} is calculated according to equation 1:
$${X}_{CH} = \frac{{m}_{o}^{p} - {m}_{f}^{p}}{{m}_{o}^{p}} \times 100 \qquad Eq . 1$$
wherein
$$( {m}_{o}^{p} )$$
is the mass of calcium hydroxide in the calcium source and
$${m}_{f}^{p}$$
is the mass of calcium hydroxide in the carbonated product mixture.

38. The method of any one of claims 1-37, wherein the method has a vaterite selectivity (Šᵥ) of at least 50%.

39. The method of claim 38, wherein \tilde{S}ᵥ is from about 60% to about 95%.

40. The method of claim 38, wherein \tilde{S}ᵥ is from about 60% to about 90%.

41. The method of claim 38, wherein \tilde{S}ᵥ is from about 60% to about 80%.

42. The method of claim 38, wherein \tilde{S}ᵥ is from about 60% to about 70%.

43. The method of any one of claims 38-42, wherein \tilde{S}ᵥ is calculated according to equation 3:
$${\tilde{s}}_{v} = \frac{{m}_{f}^{v}}{{m}_{o}^{p} - {m}_{f}^{p}} \times 100 \qquad Eq . 3$$
wherein
$${m}_{f}^{v} and {m}_{o}^{i}$$
is the final mass of vaterite.

44. The method of any one of claims 12, 14, and 15, further comprising monitoring pH in the carbonation reactor.

45. The method of any one of claims 1-44, wherein the calcium rich solution or slurry in step a) has a pH of 11 or greater.

46. The method of any one of claims 1-45, wherein step b) is terminated when the pH of the carbonation product mixture reaches 8 or less.

47. The method of any one of claims 1-46, wherein the conductivity of the carbonation product mixture is less than about half of the conductivity of the calcium rich solution or slurry in step a).

48. The method of any one of claims 1-47, wherein step d) is carried out at a drying temperature of from about 25° C. to about 100° C.

49. The method of claim 48, wherein the drying temperature is from about 45° C. to about 60° C.

50. The method of any one of claims 1-49, further comprising separating the at least one additive from the additive mixture after step c).

51. The method of any one of claims 1-50, further comprising recycling the at least one additive and the water after step c).

52. The method of any one of claims 1-51, wherein from about 40% to about 100% of the calcium in the calcium source is converted to the vaterite product.

53. The method of any one of claims 1-52, wherein the dry vaterite product comprises at least 40% vaterite.

54. The method of any one of claims 1-53, wherein the dry vaterite product comprises at least 80% vaterite.

55. The method of any one of claims 1-54, wherein the dry vaterite product comprises at least 95% vaterite.

56. The method of any one of claims 1-55, wherein carbonating the calcium rich solution or slurry with a gaseous carbon dioxide source comprises contacting the calcium rich solution or slurry with a stoichiometric excess of CO₂ relative to the amount of calcium in the calcium rich solution or slurry.

57. A vaterite product prepared by the process of any one of claims 1-56.

58. A system for preparing a vaterite product, comprising:
a carbonation reactor configured to carbonate a calcium rich solution or slurry comprising a calcium source, water, and at least one additive with a gaseous carbon dioxide source to form a carbonation product mixture, the carbonation reactor having a calcium-based solute slurry inlet, a carbon dioxide source feed inlet in fluid communication with a gaseous carbon dioxide source, an additive inlet, and a carbonation product mixture outlet;
a first separator configured to separate the carbonation product mixture to provide a wet CaCO₃ mixture, and an additive mixture comprising water and the at least one additive, the first separator having a carbonation product mixture inlet, a wet CaCO₃ product outlet, and an additives mixture outlet, wherein the carbonation product mixture outlet of the carbonation reactor is coupled to the carbonation product mixture inlet;
a drying unit configured to dry the wet CaCO₃ mixture to produce a CaCO₃ product, the drying unit having a wet CaCO₃ product mixture inlet, a dry CaCO₃ product mixture outlet, and a volatile components outlet, wherein the wet CaCO₃ product mixture outlet of the first separator is coupled to the wet CaCO₃ product mixture inlet.

59. The system of claim 58, further comprising:
a mixer having a calcium source inlet, a water inlet, and a calcium hydroxide slurry outlet coupled to the calcium-based solute slurry inlet of the carbonation reactor.

60. The system of claim 59, further comprising:
a second separator, the second separator having an additive mixture inlet, a water outlet, and an additive outlet, wherein the additive mixture outlet from the first separator is coupled to the additive mixture inlet of the second separator, and the second separator is configured to separate the at least one additive from the additive mixture.

61. The system of claim 59 or 60, wherein the mixer is configured to mix water and one or more calcium sources to form the calcium rich solution or slurry.

62. The system of any one of claims 58-61, wherein the additive inlet is adapted to receive at least one additive selected from an alcohol, an amino acid or a salt thereof, a saccharide, a polyethylene glycol, and a combination thereof.

63. A calcium carbonate composition comprising from about 40 wt % to about 100 wt % vaterite, from 0 to about 40 wt % calcium hydroxide, and less than 50 wt % calcite.

64. The composition of claim 63, comprising from about 45 wt % to about 85 wt % vaterite.

65. The composition of claim 63 or 64, comprising from 0 wt % to about 10 wt % calcite.

66. The composition of any one of claims 63-65, comprising from about 1 wt % to about 8 wt % calcite.

67. The composition of any one of claims 63-66, comprising 1 wt % to about 20 wt % calcium hydroxide.

68. The composition of any one of claims 63-67, further comprising at least one additive selected from an alcohol, an amino acid, or a salt thereof, a saccharide, a polyethylene glycol, and a combination thereof, preferably wherein the composition comprises less than 1.0 mass percent of the at least one additive.

69. The composition of claim 68, wherein the at least one additive is isopropanol.

70. The composition of any one of claims 63-69, wherein the composition gives an X-Ray diffraction pattern according to FIG. 4b, and wherein the X-Ray diffraction patterns were acquired using Panalytical X'Pert Pro X-ray Powder Diffractometer (Cu Kα radiation of 1.5410 Å) with a scanning range of 5°-70° and a scan rate with an integrated step scan of 0.021° (2θ).
